(19) United States
(12) Patent Application Publication
(10) Pub. No.: US 2006/0236600 A1
(43) Pub. Date: Oct. 26, 2006

(54) Point-of-use liquid application device

(76) Inventor: Charles J. Boegli, Cincinnati, OH (US)

Correspondence Address: GALLAGHER & DAWSEY CO., L.P.A., P.O. BOX 785, COLUMBUS, OH, 43216, US

(21) Appl. No.: 11/107,007

(22) Filed: Apr. 15, 2005

(51) Int. Cl. A01M 21/04

(52) U.S. Cl. 47/1.5; 47/1.01 R

(57) ABSTRACT

A point-of-use liquid application device adapted to be selectively adhered to a plant and activated by the fingers of a human hand. Upon activation a liquid solution is released from a liquid-tight fluid reservoir and is delivered to an individual predetermined plant. The device incorporates a primary substrate with at least one adhesive area; a backing substrate releasably covering the at least one adhesive area; a liquid-tight fluid reservoir containing a liquid solution at least partially attached to the primary substrate; and a dispersion strip in contact with a portion of the liquid-tight fluid reservoir. The design of the device facilitates attachment to the plant by wrapping the primary substrate around a portion of the plant and attaching a portion of the at least one adhesive area to a portion of the primary substrate. The liquid solution may be an herbicide and may include an absorption enhancement agent.

### TECHNICAL FIELD

The present invention relates to the field of point-of-use liquid application devices, in particular, to means for administering a single dose of a generally agricultural chemical directly to an intended site.

### BACKGROUND OF THE INVENTION

Many forms of chemical application, be they agricultural, medical, or industrial, share a common problem; it is almost always desired to apply such chemicals to a particular place or limited area, and yet most application methods either apply the chemical to an unintendedly excessive area, or are difficult and cumbersome to use when restricted application is desired.

For example, the most common method of applying agricultural chemicals is some type of spraying of a liquid or the broadcast of a fine granular mix. In either case, there is a very high chance that the chemicals will spread beyond the desired area, due to wind blown effects. Rain or high moisture will tend to dissipate the chemicals, often before they have had a chance to become effective. Such dissipation, often into the soil, has the potential to affect animals and groundwater. Additionally, in the case of potentially toxic chemicals, unintended spread may injure or kill plants or animals that are entirely unintended targets, and in fact, it is often dangerous to even enter areas that have been agriculturally sprayed for some time, lest the chemicals adhere to the body or clothing. Further, spraying requires the use of large quantities of product, much of which is not effectively delivered yet still enters the ecosystem as contamination.

Spraying is an entirely ephemeral application, with the maximum dose being limited to the amount that contacts the area during the spraying process. If absorption is slow, it is likely that the chemical will wash or blow off of the intended target before the material can be adequately absorbed. Thus, many chemicals can only be applied when certain conditions are optimal. Therefore, as one with skill in art will appreciate, spraying is a generally inefficient means of delivering chemicals.

What has been needed, and up until now unavailable, is a reliable apparatus for single dose application, at the point of use, of various chemicals, in which the chemical may be applied in concentrated form to a target area, without danger of spread via air, or to water, or by the unintended touch of humans or animals.

One effort at containment is seen in U.S. Pat. No. 6,233,866 ('866) wherein a chambered herbicide carrier contains a viscous herbicide and is fitted with a plant gripping mechanism, such as small pie shaped flaps that can grip the cut stem of a plant. The carrier is inverted and placed over a cut stem or branch of the target plant. There is no provision for sealing the herbicide within the container, and dripping is only prevented by the characteristics of the herbicide, be it the viscosity of the solution or by means of a gelled solution, which may be subject to variables such as temperature or humidity. Additionally, high viscosity solutions and gelled solutions generally are not easily absorbed by plants.

Other prior art devices are based on adhesive strips containing, or fitted with reservoirs of, various chemical formulations. U.S. Pat. No. 4,402,696 ('696) teaches an applicator having a film strip in which a central liquid filled area is surrounded by an adhesive area. Before use, the strip is maintained in a folded upon itself orientation to contain the liquid. The strip may be pulled open to apply. This system has the disadvantage of an open liquid filled area during application, which may easily be contaminated, or which, in turn, may contaminate the hands or clothing of the person applying the agent. Additionally, the device depends fully on the adhesive seal created by the edges to contain the liquid both before and after application, and it is highly likely that at least some of the liquid would drip out either before, during, or after use.

Similarly, U.S. Pat. No. 5,201,925 ('925) teaches a similar strip wherein a central active area is exposed to release a chemical, while a laterally located adhesive area is used to attach the strip to the intended target. Again, the chemical is openly exposed, in this case when a backing covering is removed, and immediately exposed to the air and to touch.

The prior art shares a number of serious shortcomings: the active ingredient is generally immediately exposed to air and touch after opening, which occurs prior to application to the intended target; and the only means of preventing the dripping or evaporation of the active ingredient lies in the quality of the seal obtained with an adhesive portion of the device. Additionally, the devices are not suitable for chemicals that must be mixed just prior to using. The instant invention solves these problems.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

The present invention is a point-of-use liquid application device adapted to be selectively adhered to a plant and activated by the fingers of a human hand. Upon activation a liquid solution is released from a liquid-tight fluid reservoir and is delivered to an individual predetermined plant. The device incorporates (a) a primary substrate with at least one adhesive area, (b) a backing substrate releasably covering the at least one adhesive area, (c) a liquid-tight fluid reservoir containing a liquid solution at least partially attached to the primary substrate, and (d) a dispersion strip in contact with a portion of the liquid-tight fluid reservoir. The design of the device facilitates attachment to the plant by wrapping the primary substrate around a portion of the plant and attaching a portion of the at least one adhesive area to a portion of the primary substrate.

These variations, modifications, alternatives, and alterations of the various preferred embodiments may be used alone or in combination with one another as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 shows a perspective view of the device having the backing substrate peeled away from the at least one adhesive area, not to scale;

FIG. 2 shows a perspective view of an embodiment of the device having the backing substrate partially peeled away from the at least one adhesive area, not to scale;

FIG. 3 shows a perspective view of an embodiment of the device having the backing substrate partially peeled away from the at least one adhesive area, not to scale;

FIG. 4 shows a perspective view of an embodiment of the device having the backing substrate partially peeled away from the at least one adhesive area, not to scale;

FIG. 5 shows a perspective view of an embodiment of the device having the backing substrate partially peeled away from the at least one adhesive area, not to scale;

FIG. 6 shows a perspective view of an embodiment of the device, not to scale;

FIG. 7 shows a front elevation view of the primary substrate of an embodiment of the device, not to scale;

FIG. 8 shows a front elevation view of the primary substrate of an embodiment of the device, not to scale;

FIG. 9 shows a front elevation view of a garden containing desirable plant and weeds with the device applied to the weeds, not to scale;

FIG. 10 shows a front perspective view of an embodiment of the present device being applied to a plant, not to scale;

FIG. 11 shows a perspective view of the device having the backing substrate peeled away from the at least one adhesive area, not to scale; and

FIG. 12 shows a perspective view of an embodiment of the device, not to scale.

Also, in the various figures and drawings, the following reference symbols and letters are used to identify the various elements described herein below in connection with the several figures and illustrations:

### DETAILED DESCRIPTION OF THE INVENTION

The point-of-use liquid application device 10 of the instant invention enables a significant advance in the state of the art. The preferred embodiments of the device 10 accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

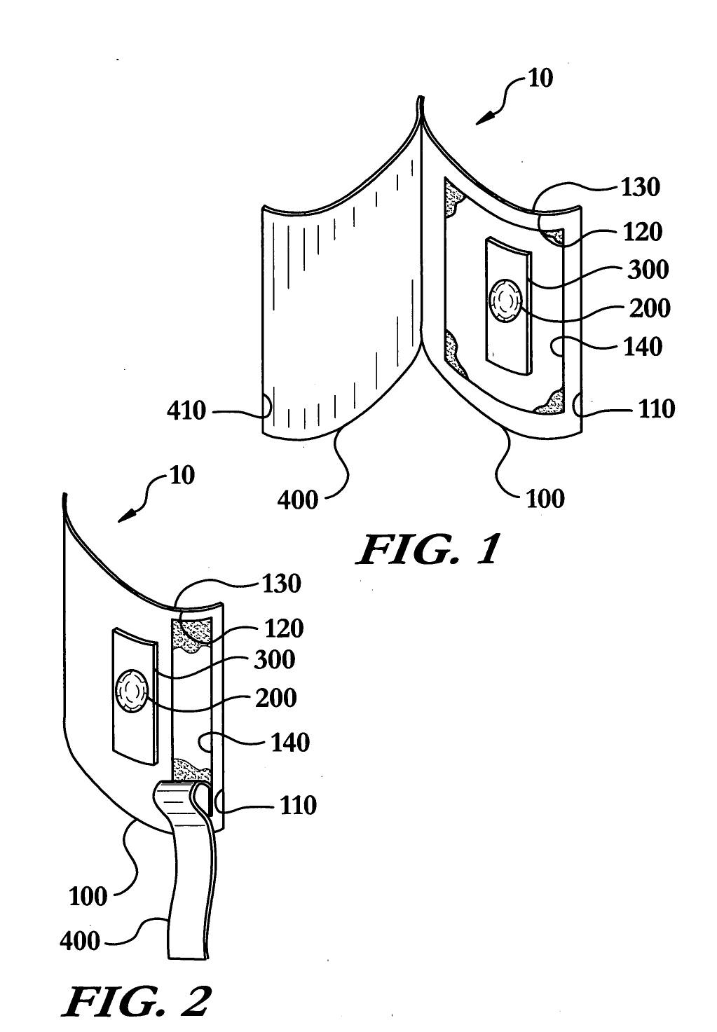

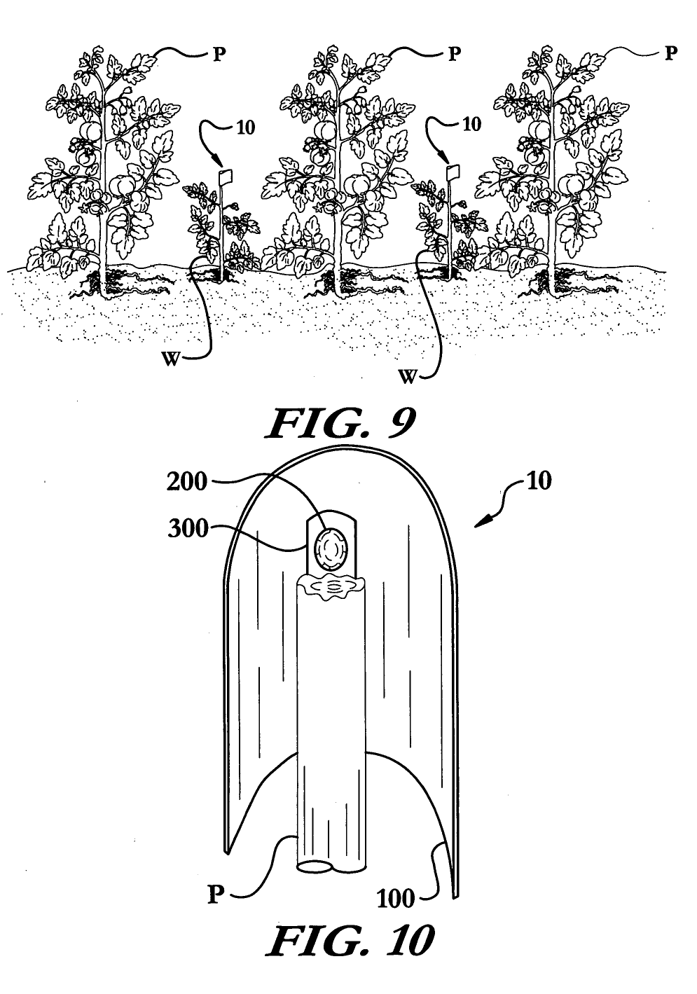

The present invention is a point-of-use liquid application device 10 adapted to be selectively adhered to a plant and activated by the fingers of a human hand. With reference to FIG. 1, the device 10 incorporates (a) a primary substrate 100 with at least one adhesive area 140, (b) a backing substrate 400 releasably covering the at least one adhesive area 140, (c) a liquid-tight fluid reservoir 200 containing a liquid solution at least partially attached to the primary substrate 100, and (d) a dispersion strip 300 in contact with a portion of the liquid-tight fluid reservoir 200. The design of the device 10 facilitates attachment to the plant by wrapping the primary substrate 100 around a portion of the plant and attaching a portion of the at least one adhesive area 140 to a portion of the primary substrate 100, as seen in FIGS. 9 and 10.

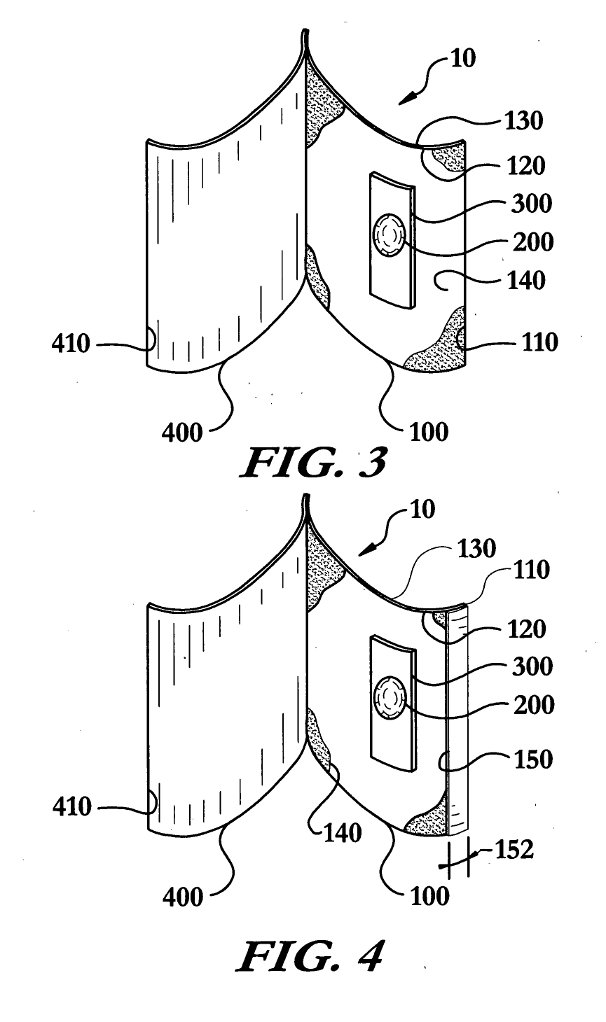

Each of the primary elements (a) through (f) above will now be further described. First, the primary substrate 100 has a perimeter edge 110, first side 120 and a second side 130, wherein the first side 120 contains the at least one adhesive area 140 containing adhesive. Although the at least one adhesive area 140 is described, and illustrated, herein as being located on the first side 120, one with skill in the art will appreciate that the at least one adhesive area 140 may be located on the second side 130. As seen in FIG. 1, the at least one adhesive area 140 may encompass virtually the entire first side 120 of the primary substrate 100 and it may be the means by which the dispersion strip 300 and the liquid-tight reservoir 200 are attached to the device 10. Alternatively, as seen in FIG. 2, the at least one adhesive area 140 may be only a small percentage of the area of the first side 120. In yet another embodiment seen in FIG. 3, the at least one adhesive area 140 includes the entire first side 120 of the primary substrate 100.

Generally any adhesive will work with the present invention, however in one particular embodiment the adhesive of the at least one adhesive area 140 is a permanent adhesive. This permanent adhesive is selected so that once it has been attached to a portion of the primary substrate 100 the at least one adhesive area 140 and the portion of the primary substrate 100 may not be detached without tearing the primary substrate 100. In other words, the adhesive strength is greater than the tensile strength of the primary substrate 100. Such an embodiment is desirable for the additional safety benefits afforded by making it extremely difficult to remove the device 10 after it has been applied to a plant and the liquid solution released from the liquid-tight fluid reservoir 200.

As seen in FIG. 4, a further embodiment may incorporate an edge separation member 150 attached to the adhesive area 140. The addition of the edge separation member 150 makes it easier for a user to remove the backing substrate 400 from the adhesive area 140, particularly when the user is wearing gloves. The edge separation member 150 extends from a portion of the perimeter edge 110 into the adhesive area 140 a predetermined distance 152 thereby ensuring a portion of the primary substrate 100 is covered by the edge separation member 150. The predetermined distance 152 is generally at least ⅛ of an inch. This covered portion of the primary substrate 100 does not adhesively attach to the backing substrate 400 permitting easy gripping and separation of the backing substrate 400 from the primary substrate 140. Introduction of the edge separation member 150 simplifies the often delicate and tedious task of separating a backing strip from an adhesive area.

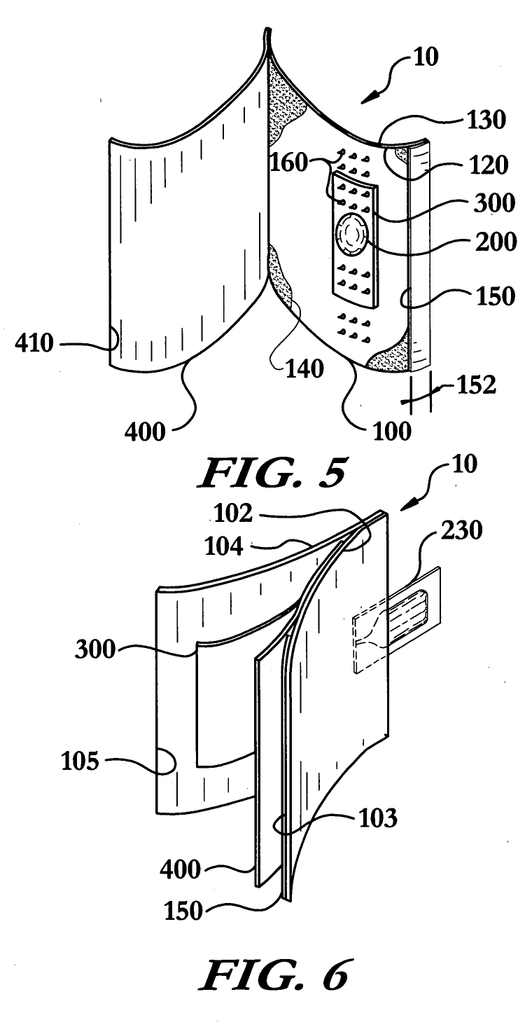

The primary substrate 100 may be constructed of virtually any pliable material. However, it is generally preferable to have the primary substrate 100 constructed of a liquid impervious substrate. Utilization of a liquid impervious primary substrate 100 protects the human fingers from contact with the liquid solution, which is desirable for the application of herbicides. This is also beneficial when applying the device to plants such as poison ivy wherein the liquid impervious primary substrate 100 prevents plant fluid from contacting the user during application of the device 10. Additionally, in yet another embodiment the primary substrate 100 is translucent so that the user can visually confirm the release of the liquid solution from the liquid-tight fluid reservoir 200. The device 10 is generally applied to an exposed portion of a plant stalk, such as that in the area of a recent clipping from the plant, or the user may crush the plant stalk with their fingers upon application of the device 10. However, the primary substrate 100 may include a plurality of surface penetration protrusions 160 to pierce the plant stalk and further assist in delivery of the liquid solution, as seen in FIG. 5. The surface penetration protrusions 160 may range from simply a rough sandpaper-like texture on the primary substrate 100 all the way to miniature spikes extending from the primary substrate 100, as illustrated in FIG. 5.

In yet a further embodiment, illustrated in FIG. 6, the primary substrate 100 includes a first section 102 and a second section 104, wherein the at least one adhesive area 140, not shown, is located on the first section 102 and the dispersion strip 300 is located on the second section 104. The first section 102 and the second section 104 are configured to permit the point-of-use liquid application device 10 to be attached to the plant by wrapping the primary substrate 100 around a portion of the plant and attaching the first section 102 to the second section 104. In the embodiment illustrated in FIG. 6, the first section 102 and the second section 104 are individual elements joined together, however one with skill in the art will appreciate that the first section 102 and the second section 104 may be formed of a single piece of substrate. In this embodiment the at least one adhesive area 140 covers at least twenty-percent of the surface area of a first section application side 103 and the dispersion strip 300 is attached to the second section 104 and covers at least fifty-percent of the surface area of a second section application side 105. Additionally, in this embodiment the liquid-tight fluid reservoir 200 is a capsule 230 partially attached to the first section 102 and the second section 104, and the first section 102 incorporates an edge separation member to ease separation of the backing substrate 400 from the first section 102.

Second, the backing substrate 400 has a perimeter edge 410 and is releasably attached to, and covers, the at least one adhesive area 140, as seen in FIG. 1 wherein a portion of the backing substrate 400 has been separated from the at least one adhesive area 140 for purposes of illustration. The backing substrate 400 is grippable by human fingers and is removable to expose the at least one adhesive area 140 thereby permitting the device 10 to be attached to the plant by wrapping the primary substrate 100 around a portion of the plant and attaching a portion of the at least one adhesive area 140 to a portion of the primary substrate 100, and optionally to the plant itself. In one particular embodiment the backing substrate 400 includes a silicone coating to aid in the release of the backing substrate 400 from the at least one adhesive area 140 of the primary substrate 100. Another embodiment of the backing substrate 400 is illustrated in FIG. 2 wherein the at least one adhesive area 140 only covers a small portion of the first side 120 of the primary substrate 100 and the backing substrate 400 only covers this small adhesive area 140.

Third, the liquid-tight fluid reservoir 200 is designed to release the liquid solution when subjected to manipulation by human fingers. In one embodiment, the fingers apply a force which increases the pressure of the liquid solution above a predetermined release pressure after attachment of the device 10 to the plant P. Alternatively, the manipulation may result in flexure or bending of the liquid-tight fluid reservoir 200 resulting in predetermined release of the liquid solution. Still further, the manipulation may consist of tearing or puncturing a portion of the liquid-tight fluid reservoir 200. Additionally, the manipulation may result in a predetermined cracking or peeling of the liquid-tight fluid reservoir 200, thereby permitting a controlled release of the liquid solution.

The liquid-tight fluid reservoir 200 may be constructed in any number of ways and with any number of materials. The liquid-tight fluid reservoir 200 is generally constructed with at least a portion of the reservoir 200 being a pliable material.

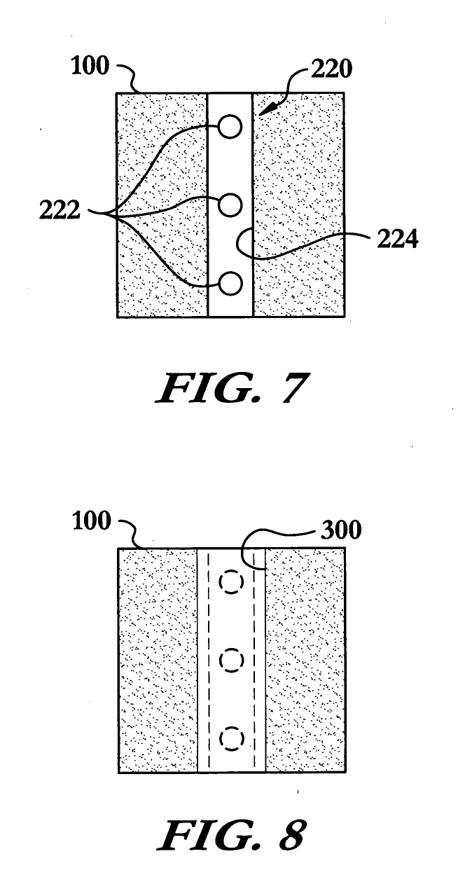

In one particular embodiment, illustrated in FIG. 7 without the backing substrate 400, the liquid-tight fluid reservoir 200 is a portion of a ribbon reservoir system 220 having a plurality of reservoir pouches 222 containing the liquid solution. In this embodiment the plurality of reservoir pouches 222 are interconnected by a continuous ribbon 224. As one with skill in the art will appreciate, this embodiment leads to particularly efficient manufacturing of the device 10 in large quantities via a web-type continuous manufacturing process wherein the primary substrate 100 is a continuous roll of material which is then coated with adhesive on one side and the ribbon reservoir system 220, also in continuous roll form, is then rolled onto the adhesive. Similarly, the dispersion strip 300 may also be in continuous roll form and be slightly wider than the ribbon reservoir system 220 so that it may be rolled out over the ribbon reservoir system 220, yet still having the edges extend beyond those of the ribbon reservoir system 220 so that they are in contact with the adhesive, as illustrated in FIG. 8. The assembled roll product may then be cut into the individual devices 10, or perforations may be made in the assembled roll product so that individual devices 10 may be torn from the roll as needed. In this embodiment the user can feel the location of the reservoir pouch 222 through the primary substrate 100 after the device is applied to the plant and squeeze the reservoir pouch 222 to release the liquid solution.

In an alternative embodiment, referring again to FIG. 6, the liquid-tight fluid reservoir 200 is a capsule 230 partially attached to the primary substrate 100 such that a portion of the capsule 230 is within the perimeter edge 110 and a portion of the capsule 230 extends beyond the perimeter edge 110. The capsule 230 extends from the primary substrate 100 such that it is easily gripped and manipulated by human fingers F. In such embodiments where the reservoir 200 is exposed to view it is preferable to construct the reservoir 200 of a translucent or a clear material so that the user can view the contents of the reservoir 200 to confirm the release of the liquid solution.

In a further embodiment, illustrated in FIG. 12, the device 10 incorporates at least two liquid-tight fluid reservoirs 200 in the form of capsules 230. The second capsule 230 contains a second liquid solution, generally different than the liquid solution in the other capsule 230. In this embodiment, both capsules 230 are at least partially attached to the primary substrate 100.

Further, in this embodiment, each capsule 230 is designed to release its liquid solution when subjected to a force applied by human fingers after attachment of the point-of-use liquid application device 10 to the plant P, and the capsules 230 are configured to be in contact with a portion of the dispersion strip 300 so that the solutions are released onto the dispersion strip 300.

Fourth, the dispersion strip 300 is designed to capture and disperse the liquid solution throughout the dispersion strip 300 as it is released from the liquid-tight reservoir 200. The dispersion strip 300 is generally constructed of an absorbent material that effectively distributes the liquid solution throughout the dispersion strip 300. In one particular safety-minded embodiment the dispersion strip 300 is constructed of an absorbent material with an absorption capacity greater than or equal to the volume of the liquid solution. In such an embodiment, if there is an inadvertent release of the liquid solution from the liquid-tight reservoir 200, the dispersion strip 300 has the capacity to absorb all of the liquid solution, thereby reducing, and often eliminating, release of the liquid solution from the device 10. In yet a further embodiment, the dispersion strip 300 is constructed of a hydrophilic material. Constructing the dispersion strip 300 of hydrophilic material aids in the distribution of water based liquid solutions throughout the dispersion strip 300, thereby resulting in more effective application of the liquid solution. The dispersion strip 300 may cover majority of the first side 120 of the primary substrate 100, or it may only cover a small portion of it, however it has been found to be particularly effective when the dispersion strip 300 covers at least ten percent of the area of the first side 120.

The liquid-tight fluid reservoir 200 may house any number of liquids. In one particular embodiment the liquid solution is an herbicide intended to kill the plant upon which the device 10 is applied. Alternatively, in other embodiments the liquid solution may be a solution intended to fertilize, or apply medication, to the plant. In a further embodiment, the liquid solution includes a marker dye system so that a user can easily confirm release of the liquid solution from the liquid-tight fluid reservoir 200. This embodiment works particularly well with the previously described embodiment in which the primary substrate 100 is translucent. The marker dye is preferably a dark color so that the release of the liquid solution is easily visually perceivable.

In yet another embodiment, the liquid solution includes an absorption enhancement agent to increase the rate that the liquid solution is absorbed by the plant. This is particularly helpful in the delivery of herbicides where the goal is to kill the undesirable plant as quickly as possible.

Various absorption enhancement agents may be incorporated into the liquid solution, but in one particular embodiment the absorption enhancement agent is selected from the group consisting of nitrogen fertilizers, phosphate fertilizers, and potassium fertilizers, and mixtures thereof. Such fertilizers are often referred to as N—P—K fertilizers and will accelerate the absorption of herbicides by plants.

In a further variation, the absorption enhancement agent is incorporated within the dispersion strip 300 as a dry ingredient that mixes with the liquid solution upon release from the liquid-tight fluid reservoir 200. Still further, when the absorption enhancement agent is incorporated within the dispersion strip 300 as a dry ingredient it may be selected to react with the liquid solution, thereby forming a new compound or mixture. In this manner, useful or potent compounds can be formed at the point of activation, thereby providing an additional measure of safety in the device 10. The new compound or mixture formed by such a reaction may even be unstable, as long as it exists for enough time to perform the required action. Various methods of incorporating the absorption enhancement agent into the dispersion strip 300 may be used, and are known to those with skill in the art.

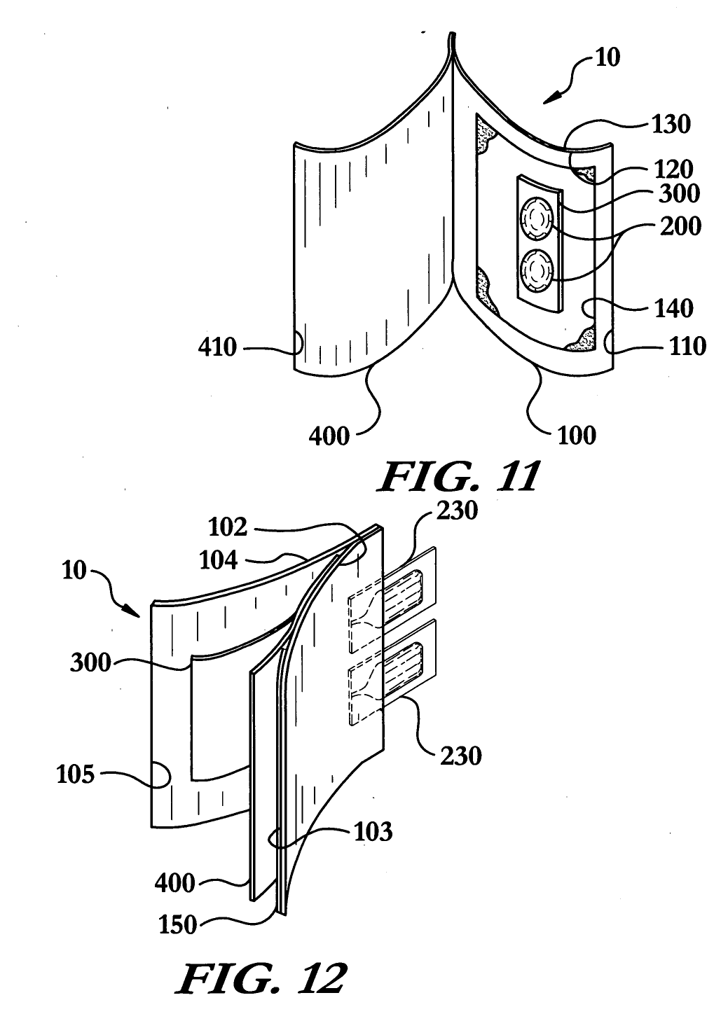

Additionally, the device 10 may incorporate a multi-part fluid delivery system. For example, a single device 10 may include multiple liquid-tight fluid reservoirs 200, as seen in FIG. 11. The second liquid-tight fluid reservoir 200 of FIG. 11 contains a second liquid solution at least partially attached to the primary substrate 100. Further, the second liquid-tight fluid reservoir 200 is designed to release the liquid solution when subjected to a force applied by human fingers after attachment of the point-of-use liquid application device 10 to the plant P, and the second liquid-tight fluid reservoir 200 is configured to be in contact with a portion of the dispersion strip 300 so that the second liquid solution of the second liquid-tight fluid reservoir 200 is released onto the dispersion strip 300.

In such an embodiment each liquid-tight fluid reservoirs 200 may contain a different liquid solution. The liquid solutions are then mixed, or react with one another, only when released by the associated liquid-tight fluid reservoirs 200. The mixture, or reaction, of the liquid solutions may form a new compound or mixture. In this manner, useful or potent compounds can be formed at the point of activation, thereby providing an additional measure of safety in the device 10. The new compound or mixture formed by such a reaction may even be unstable, as long as it exists for enough time to perform the required action.

The point-of-use liquid application device 10 of the present application is particularly effective at administering lethal doses of herbicide to unwanted plants, namely weeds W, in a crowded garden without affecting desirable plants P in the immediate area, such as the plants in FIG. 9. Generally in the application of the device 10 to a weed W, such as that of FIG. 9, a portion of the weed W will be clipped off to expose the interior of the weed W and then the device 10 will be applied in the immediate vicinity of the exposed interior.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. A point-of-use liquid application device (10) adapted to be selectively adhered to a plant (P) and activated by the fingers of a human hand, comprising:
a primary substrate (100) having a perimeter edge (110), first side (120) and a second side (130), wherein the first side (120) has at least one adhesive area (140) having adhesive;
a backing substrate (400), having a perimeter edge (410), releasably attached to, and covering, the at least one adhesive area (140), wherein the backing substrate (400) is grippable by human fingers and removable to expose the at least one adhesive area (140) thereby permitting the point-of-use liquid application device (10) to be attached to the plant (P) by wrapping the primary substrate (100) around a portion of the plant (P) and attaching a portion of the at least one adhesive area (140) to a portion of the primary substrate (100);
a liquid-tight fluid reservoir (200) containing a liquid solution at least partially attached to the primary substrate (100), wherein the liquid-tight fluid reservoir (200) is designed to release the liquid solution when subjected to a force applied by human fingers after attachment of the point-of-use liquid application device (10) to the plant (P); and
a dispersion strip (300) in contact with a portion of the liquid-tight fluid reservoir (200) designed to capture and disperse the liquid solution throughout the dispersion strip (300) as it is released from the liquid-tight reservoir (200).

2. The point-of-use liquid application device (10) according to claim 1, wherein the at least one adhesive area (140) includes the entire first side (120) of the primary substrate (100).

3. The point-of-use liquid application device (10) according to claim 2, further including an edge separation member (150) attached to the adhesive area (140) and extending from a portion of the perimeter edge (110) into the adhesive area (140) a predetermined distance (152) thereby ensuring a portion of the primary substrate (100) is covered by the edge separation member (150) and does not adhesively attach to the backing substrate (400) further permitting easy gripping and separation of the backing substrate (400) from the primary substrate (140).

4. The point-of-use liquid application device (10) according to claim 1, further including a second liquid-tight fluid reservoir (200) containing a second liquid solution at least partially attached to the primary substrate (100), wherein the second liquid-tight fluid reservoir (200) is designed to release the liquid solution when subjected to a force applied by human fingers after attachment of the point-of-use liquid application device (10) to the plant (P), and the second liquid-tight fluid reservoir (200) is configured to be in contact with a portion of the dispersion strip (300) so that the second liquid solution of the second liquid-tight fluid reservoir (200) is released onto the dispersion strip (300).

5. The point-of-use liquid application device (10) according to claim 1, wherein the liquid-tight fluid reservoir (200) is a portion of a ribbon reservoir system (220) having a plurality of reservoir pouches (222) containing the liquid solution designed to release the liquid solution when subjected to a predetermined force applied by human fingers which increases the pressure of the liquid solution above a predetermined release pressure, wherein the plurality of reservoir pouches (222) are interconnected by a continuous ribbon (224).

6. The point-of-use liquid application device (10) according to claim 5, wherein the at least one adhesive area (140) includes the entire first side (120) of the primary substrate (100) and the ribbon reservoir system (220) is continuously attached to the first side (120).

7. The point-of-use liquid application device (10) according to claim 1, wherein the liquid-tight fluid reservoir (200) is a capsule (230) partially attached to the primary substrate (100) such that a portion of the capsule (230) is within the perimeter edge (110) and a portion of the capsule (230) extends beyond the perimeter edge (110) such that it is easily gripped and manipulated by human fingers.

8. The point-of-use liquid application device (10) according to claim 1, wherein the liquid solution is an herbicide.

9. The point-of-use liquid application device (10) according to claim 1, wherein the liquid solution is a nutrient rich solution.

10. The point-of-use liquid application device (10) according to claim 1, wherein the primary substrate (100) is a liquid impervious substrate thereby protecting the human fingers from contact with the liquid solution.

11. The point-of-use liquid application device (10) according to claim 1, wherein the primary substrate (100) is translucent and the liquid solution includes a marker dye system so that a user can easily confirm release of the liquid solution from the liquid-tight fluid reservoir (200).

12. The point-of-use liquid application device (10) according to claim 1, wherein the liquid solution includes an absorption enhancement agent to increase the rate that the liquid solution is absorbed by the plant.

13. The point-of-use liquid application device (10) according to claim 12, wherein the absorption enhancement agent is selected from the group consisting of nitrogen fertilizers, phosphate fertilizers, and potassium fertilizers, and mixtures thereof.

14. The point-of-use liquid application device (10) according to claim 1, wherein the dispersion strip (300) incorporates an absorption enhancement agent that mixes with the liquid solution as it is dispersed throughout the dispersion strip (300) to increase the rate that the liquid solution is absorbed by the plant.

15. The point-of-use liquid application device (10) according to claim 14, wherein the absorption enhancement agent is selected from the group consisting of nitrogen fertilizers, phosphate fertilizers, and potassium fertilizers, and mixtures thereof.

16. The point-of-use liquid application device (10) according to claim 1, wherein the dispersion strip (300) is constructed of an absorbent material with an absorption capacity greater than or equal to the volume of the liquid solution.

17. The point-of-use liquid application device (10) according to claim 1, wherein the dispersion strip (300) is constructed of a hydrophilic material.

18. The point-of-use liquid application device (10) according to claim 1, wherein the backing substrate (400) includes a silicone coating to aid in the release of the backing substrate (400) from the at least one adhesive area (140) of the primary substrate (100).

19. The point-of-use liquid application device (10) according to claim 1, wherein the adhesive of the at least one adhesive area (140) is a permanent adhesive so that once it has been attached to a portion of the primary substrate (100) the at least one adhesive area (140) and the portion of the primary substrate (100) may not be detached without tearing the primary substrate (100).

20. The point-of-use liquid application device (10) according to claim 1, wherein the primary substrate (100) includes a first section (102) and a second section (104), wherein the at least one adhesive area (140) is located on the first section (102) and the dispersion strip (300) is located on the second section (104), and the first section (102) and the second section (104) are configured to permit the point-of-use liquid application device (10) to be attached to the plant (P) by wrapping the primary substrate (100) around a portion of the plant (P) and attaching the first section (102) to the second section (104).

21. The point-of-use liquid application device (10) according to claim 20, wherein the first section (102) and the second section (104) are individual elements joined together, and the at least one adhesive area (140) covers at least twenty-percent of the surface area of a first section application side (103) and wherein the dispersion strip (300) is attached to the second section (104) and covers at least twenty-percent of the surface area of a second section application side (105).

22. The point-of-use liquid application device (10) according to claim 21, wherein the liquid-tight fluid reservoir (200) is a capsule (230) partially attached to the first section (102) and the second section (104).

23. The point-of-use liquid application device (10) according to claim 1, wherein the primary substrate (100) is formed to have a plurality of surface penetration protrusions (160) to pierce the plant stalk and further assist in delivery of the liquid solution.

24. A point-of-use liquid application device (10) adapted to be selectively adhered to a plant (P) and activated by the fingers of a human hand, comprising:
a liquid impervious primary substrate (100) having a perimeter edge (110), first side (120) and a second side (130), wherein the first side (120) has at least one adhesive area (140) having permanent adhesive that has an adhesive strength greater than the tensile strength of the primary substrate (100);
a backing substrate (400), having a perimeter edge (410), releasably attached to, and covering, the at least one adhesive area (140), wherein the backing substrate (400) is grippable by human fingers and removable to expose the at least one adhesive area (140) thereby permitting the point-of-use liquid application device (10) to be attached to the plant (P) by wrapping the primary substrate (100) around a portion of the plant (P) and attaching a portion of the at least one adhesive area (140) to a portion of the primary substrate (100);
a liquid-tight fluid reservoir (200) wherein the liquid-tight fluid reservoir (200) is a portion of a ribbon reservoir system (220) having a plurality of reservoir pouches (222) containing the liquid solution designed to release the liquid solution when subjected to a predetermined force applied by human fingers after attachment of the point-of-use liquid application device (10) to the plant (P), wherein the plurality of reservoir pouches (222) are interconnected by a continuous ribbon (224); and
a dispersion strip (300) in contact with a portion of the liquid-tight fluid reservoir (200) designed to capture and disperse the liquid solution throughout the dispersion strip (300) as it is released from the liquid-tight reservoir (200), wherein the dispersion strip (300) is constructed of an absorbent material with an absorption capacity greater than or equal to the volume of the liquid solution.

25. A point-of-use liquid application device (10) adapted to be selectively adhered to a plant (P) and activated by the fingers of a human hand, comprising:
a liquid impervious primary substrate (100) having a perimeter edge (110), first side (120) and a second side (130), wherein the first side (120) has at least one adhesive area (140) having permanent adhesive that has an adhesive strength greater than the tensile strength of the primary substrate (100), wherein the primary substrate (100) includes a first section (102) and a second section (104) and the at least one adhesive area (140) is located on the first section (102) and covers at least twenty-percent of the surface area of a first section application side (103);
a backing substrate (400), having a perimeter edge (410), releasably attached to, and covering, the at least one adhesive area (140), wherein the backing substrate (400) is grippable by human fingers and removable to expose the at least one adhesive area (140) thereby permitting the point-of-use liquid application device (10) to be attached to the plant (P) by wrapping the primary substrate (100) around a portion of the plant (P) and attaching the first section (102) to the second section (104);
a capsule (230) partially attached to the attached to the first section (102) and the second section (104) such that a portion of the capsule (230) is within the perimeter edge (110) and a portion of the capsule (230) extends beyond the perimeter edge (110) such that it is easily gripped and squeezed by human fingers, wherein the capsule (230) is designed to release the liquid solution when subjected to a force applied by human fingers after attachment of the point-of-use liquid application device (10) to the plant (P); and
a dispersion strip (300) attached to the second section (104) and covering at least twenty-percent of the surface area of a second section application side (105), the dispersion strip (300) being in contact with a portion of the capsule (230) designed to capture and disperse the liquid solution throughout the dispersion strip (300) as it is released from the capsule (230), wherein the dispersion strip (300) is constructed of an absorbent material with an absorption capacity greater than or equal to the volume of the liquid solution.
